(19) United States
(12) Patent Application Publication
(10) Pub. No.: US 2024/0232546 A9
(43) Pub. Date: Jul. 11, 2024

(54) METHOD FOR SPEECH-TO-SPEECH CONVERSION

(71) Applicant: GOOGLE LLC, Mountain View, CA (US)

(72) Inventors: Oleg RYBAKOV, Redmond, WA (US); Fadi BIADSY, Sandyston, NJ (US)

(73) Assignee: GOOGLE LLC, Mountain View, CA (US)

(21) Appl. No.: 18/493,268

(22) Filed: Oct. 24, 2023

Related U.S. Application Data
(60) Provisional application No. 63/418,906, filed on Oct. 24, 2022.

(51) Int. Cl. G06F 40/58; G10L 15/02; G10L 15/30; G10L 19/032

(52) U.S. Cl. CPC G06F 40/58; G10L 15/02; G10L 15/30; G10L 19/032

(57) ABSTRACT

The present disclosure relates to a streaming speech-to-speech conversion model, where an encoder runs in real time while a user is speaking, then after the speaking stops, a decoder generates output audio in real time. A streaming-based approach produces an acceptable delay with minimal loss in conversion quality when compared to other non-streaming server-based models. A hybrid model approach for combines look-ahead in the encoder and a non-causal stacker with non-causal self-attention.

### CROSS-REFERENCE TO RELATED APPLICATIONS

The present application claims priority to U.S. Provisional Application No. 63/418,906, filed Oct. 24, 2022, the entire content of which is incorporated by reference herein in its entirety for all purposes.

### FIELD OF THE INVENTION

The present disclosure relates to streaming speech-to-speech conversion.

### BACKGROUND

The background description provided herein is for the purpose of generally presenting the context of the disclosure. Work of the presently named inventors, to the extent the work is described in this background section, as well as aspects of the description that may not otherwise qualify as prior art at the time of filing, are neither expressly nor impliedly admitted as prior art against the present disclosure.

With increases in the computational resources of mobile devices and advances in speech modeling, on-device inference generation from speech audio has become an important research topic. Automatic Speech Recognition (ASR) and Text to Speech (TTS) synthesis, and machine translation models, for example, have been ported successfully to run locally on mobile devices with great success.

### SUMMARY

The present disclosure relates to a method of speech-to-speech conversion, including converting received audio data in a first language to acoustic characteristics of an utterance in the first language, the audio data comprising a sequence of acoustic frames; generating, via an encoder, an encoded sequence including first acoustic features representing first speech in the first language based on the acoustic characteristics, the encoder using a combination of look-ahead stacking of the acoustic frames and look-ahead self-attention of the acoustic frames; generating, via a decoder, second acoustic features representing second speech in a second speech pattern based on the encoded sequence; generating, via a vocoder, a waveform of the second speech in the second speech pattern based on the second acoustic features; and outputting the waveform of the second speech in the second speech pattern.

The present disclosure additionally relates to a non-transitory computer-readable storage medium for storing computer-readable instructions that, when executed by a computer, cause the computer to perform a method, the method including converting received audio data in a first language to acoustic characteristics of an utterance in the first language, the audio data comprising a sequence of acoustic frames; generating, via an encoder, an encoded sequence including first acoustic features representing first speech in the first language based on the acoustic characteristics, the encoder using a combination of look-ahead stacking of the acoustic frames and look-ahead self-attention of the acoustic frames; generating, via a decoder, second acoustic features representing second speech in a second speech pattern based on the encoded sequence; generating, via a vocoder, a waveform of the second speech in the second speech pattern based on the second acoustic features; and outputting the waveform of the second speech in the second speech pattern.

The present disclosure additionally relates to an apparatus, including processing circuitry configured to convert received audio data in a first language to acoustic characteristics of an utterance in the first language, the audio data comprising a sequence of acoustic frames, generate, via an encoder, an encoded sequence including first acoustic features representing first speech in the first language based on the acoustic characteristics, the encoder using a combination of look-ahead stacking of the acoustic frames and look-ahead self-attention of the acoustic frames, generate, via a decoder, second acoustic features representing second speech in a second speech pattern based on the encoded sequence, generate, via a vocoder, a waveform of the second speech in the second language based on the second acoustic features, and output the waveform of the second speech in the second language.

Note that this summary section does not specify every embodiment and/or incrementally novel aspect of the present disclosure or claimed invention. Instead, this summary only provides a preliminary discussion of different embodiments and corresponding points of novelty. For additional details and/or possible perspectives of the invention and embodiments, the reader is directed to the Detailed Description section and corresponding figures of the present disclosure as further discussed below.

### BRIEF DESCRIPTION OF THE DRAWINGS

Various embodiments of this disclosure that are proposed as examples will be described in detail with reference to the following figures, wherein like numerals reference like elements, and wherein:

FIG. 1 is a schematic view of a system, according to an embodiment of the present disclosure.

FIG. 2A is a schematic of a non-streaming self-attention speech model.

FIG. 2B is a schematic of a causal self-attention speech model.

FIG. 2C is a schematic of a self-attention speech model with look-ahead, according to an embodiment of the present disclosure.

FIG. 3 is a schematic of the streaming speech-to-speech model architecture with look-ahead, according to an embodiment of the present disclosure.

FIG. 4 is a schematic of the structure of the hybrid look-ahead model, according to an embodiment of the present disclosure.

FIG. 5 is a graph of the float32 model accuracy versus delay trade-off (with streaming encoder decoder sDec and vocoder sGL1), according to an embodiment of the present disclosure.

FIG. 6 is a flow chart for a method of generating translated audio, according to an embodiment of the present disclosure.

FIG. 7 is a block diagram illustrating an exemplary electronic user device, according to an embodiment of the present disclosure.

FIG. 8 is a schematic of a hardware system for performing a method, according to an embodiment of the present disclosure.

FIG. 9 is a schematic of a hardware configuration of a device for performing a method, according to an embodiment of the present disclosure.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed. Further, spatially relative terms, such as “top,” “bottom,” “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

The order of discussion of the different steps as described herein has been presented for clarity sake. In general, these steps can be performed in any suitable order. Additionally, although each of the different features, techniques, configurations, etc. herein may be discussed in different places of this disclosure, it is intended that each of the concepts can be executed independently of each other or in combination with each other. Accordingly, the present disclosure can be embodied and viewed in many different ways.

Described herein is a fully on-device end-to-end Speech to Speech (STS) conversion model that normalizes a given input speech directly to synthesized output speech. Deploying such an end-to-end model locally on mobile devices poses significant challenges in terms of memory footprint and computation requirements. In the present disclosure, a streaming-based approach to produce an acceptable delay with minimal loss in conversion quality is described, especially when compared to a non-streaming server-based model. The streaming-based approach described herein includes first streaming an encoder in real time while a speaker is speaking, and as soon as the speaker stops speaking, a spectrogram decoder can be run in streaming mode alongside a streaming vocoder to rapidly generate output speech in real time. To achieve an acceptable delay—quality trade off, a hybrid approach for look-ahead in the encoder is discussed and combined with a look-ahead feature stacker with a look-ahead self-attention. In addition, the model with int4 quantization aware training and int8 post training quantization is optimized to show that the streaming approach described herein is approximately 2× faster than real time on a Pixel4 CPU.

In particular, the challenges of running an attention-based speech-to-speech model on mobile phones are addressed, focusing on speech conversion. In general, speech-to-speech models have several applications, including speech-to-speech translation, speech conversion and normalization, and speech separation.

The method described herein has shown to successfully convert atypical speech from speakers with speech impairments (due to, for example, deafness, Parkinsons, ALS, stroke, etc.) directly to fluent typical speech, while also producing automatic transcripts in parallel. To achieve optimal results, the method herein has been adapted and personalized for each dysarthric speaker, producing a Submodel for each user. Running a personalized model locally on every device can have substantial practical advantages over server-based models, including: scalability, inference without internet connectivity, reduced latency, and privacy.

Unlike TTS and ASR, both the input and output of STS models are acoustic frames—i.e., significantly longer input-output sequences and typically larger models that include more parameters. Due to these extra challenges, when running the inference generation on-device, the model size can be sufficiently small to fit random access memory (RAM) and the model can run with limited compute resources. Notably, running all the components of the model in non-streaming mode substantially increases the delay between the time the speaker stops speaking until obtaining the converted speech. Controlling the latency of the model can be advantageous for natural human-to-human communication, especially when the model is the only mode of communication for particular groups, such as dysarthric speakers.

There are several approaches for speech-to-speech streaming. One approach includes streaming the encoder and decoder simultaneously so that the model generates new speech while the speaker or user is speaking. Another approach includes only streaming the encoder while the user is speaking, and then stream the decoder to generate new speech afterward, similar to the way the decoder runs in TTS. The latter approach can be well-suited for a face-to-face dialog and the quality loss in comparison to the baseline model can be minimized.

To achieve the aforementioned desired performance, the streaming conformer encoder is used and run on-device in real time while the user is speaking. Notably, streaming self-attention with look-ahead is used, and the impact of a non-causal stacker in the encoder in combination with non-causal streaming self-attention of conformer layers is investigated. A modified decoder is used which can be streamed and combined with the streaming vocoder. To minimize quality loss, the number of model parameters in the streaming and non-streaming versions is kept the same. To reduce model size, int8 post training quantization with int4 quantization aware training is applied.

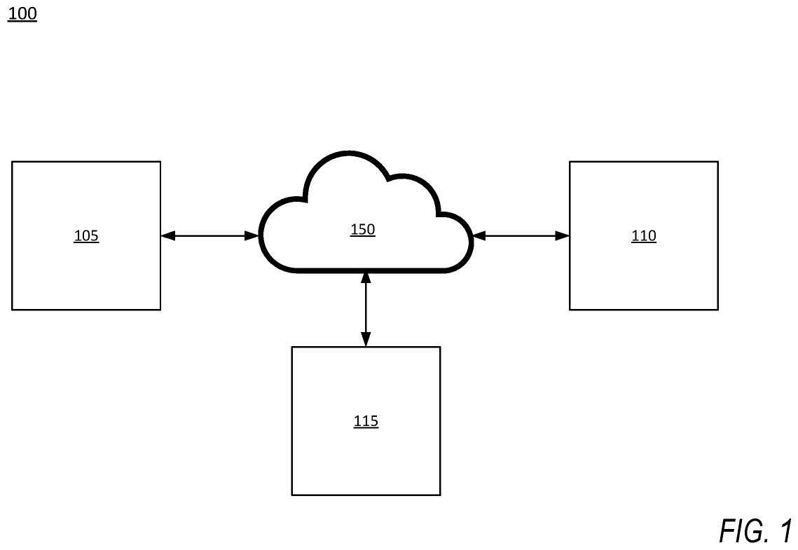

Referring now to the Drawings, FIG. 1 is a schematic view of a system 100, according to an embodiment of the present disclosure. In an embodiment, the system 100 can include a first electronic device 105, such as a client/user device, communicatively connected to a second electronic device 110, such as a server, via a network 150. A third electronic device 115 can be communicatively connected to the first electronic device 105 and the second electronic device 110. The devices can be connected via a wired or a wireless connection. The connection between, for example, the first electronic device 105 and the second electronic device 110 can be via the network 150, wherein the network 150 is wireless. In an embodiment, the first electronic device 105 can be configured to obtain data from the user (of the first electronic device 105), such as speech audio. Notably, the first electronic device 105 can transmit the data over the communication network 150 to the networked second electronic device 110 and/or the third electronic device 115.

In an embodiment, the first electronic device 105 need not be communicatively coupled to the other device or the network 150. That is, the method described herein can be run entirely on the first electronic device 105 using the obtained data, such as the obtained speech audio.

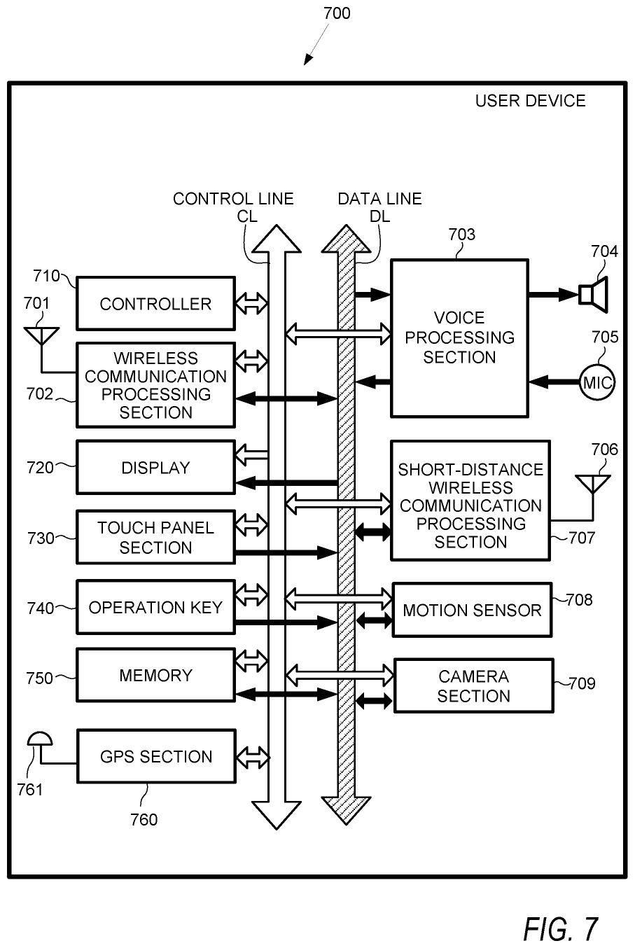

In an embodiment, the first electronic device 105 can include a central processing unit (CPU), among other components (discussed in more detail in FIGS. 7-9). An application can be installed or accessible on the first electronic device 105 for executing the methods described herein. The application can also be integrated into an operating system (OS) of the first electronic device 105. The first electronic device 105 can be any electronic device such as, but not limited to, a smart-phone, a personal computer, a tablet pc, a smart-watch, a smart-television, an interactive screen, an IoT (Internet of things) device, or the like. Notably, the first electronic device 105 can be used by a user, such as a speaker having a first speech pattern, to generate the audio data in the first speech pattern. The first speech pattern can be, for example, atypical speech from speakers with speech impairments. The first speech pattern can also be, for example, speech from speakers without speech impairments. To generate a translated version of the audio data in a second speech pattern, the speaker can send, via the first electronic device 105, the audio data in the speaker's first speech pattern to the second electronic device 110 to generate translated audio data in the second speech pattern. That is to say, the first electronic device 105 can collect or obtain the audio data and transmit the audio data to a server (the second electronic device 110) for processing, which can result in a small introduction of delay due to the transmit time. Furthermore, such a process would also entail a communication connection between the first device 105 and the server. However, the server can, based on the resources included on the server, provide improved computation power and overall accuracy (for any given personalized user model). Although the above description was discussed with respect to the first electronic device 105, it is to be understood that the same description applies to the other devices (110 and 115) of FIG. 1.

Furthermore, as previously described, the first device 105 can obtain the audio data in the first speech pattern and analyze and process the audio data into the translated audio data in the second speech pattern entirely on the first device 105. Additionally or alternatively, the audio data in the first speech pattern need not be from a human speaking in real time, but can also be audio being played from an audio source, such as audio from a pre-saved audio clip or video, audio from a web conferencing application including other participants/speakers, etc.

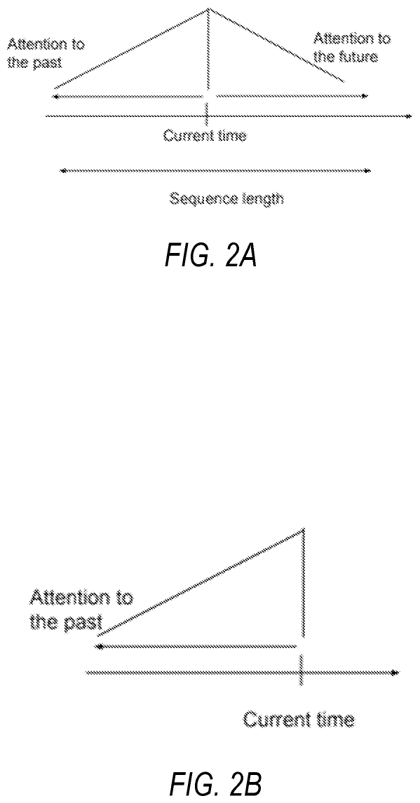

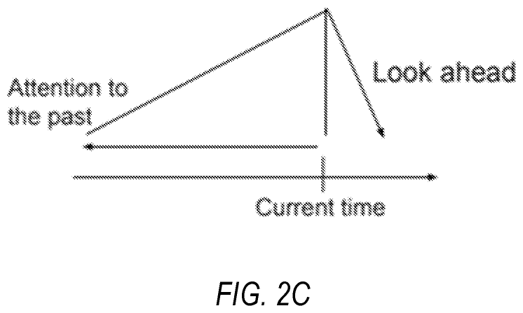

FIG. 2A is a schematic of a non-streaming self-attention speech model. The schematic demonstrates an amount of attention paid to the speech as a function of time. The speech-to-speech model is based on a conformer encoder which uses self-attention over the whole sequence, making it not able to stream.

FIG. 2B is a schematic of a causal self-attention speech model. To make the model streamable, a causal conformer encoder can be used, but the accuracy can decrease as a result.

To this end, FIG. 2C is a schematic of a self-attention speech model with look-ahead, according to an embodiment of the present disclosure. In an embodiment, to address the accuracy issue, the self-attention can attend to the future samples. For example, 500 ms of future audio data can be used. By extension, this model will have the 500 ms of introduced delay, but the speech model quality can be better than the causal self-attention speech model while having less delay than the non-streaming self-attention speech model.

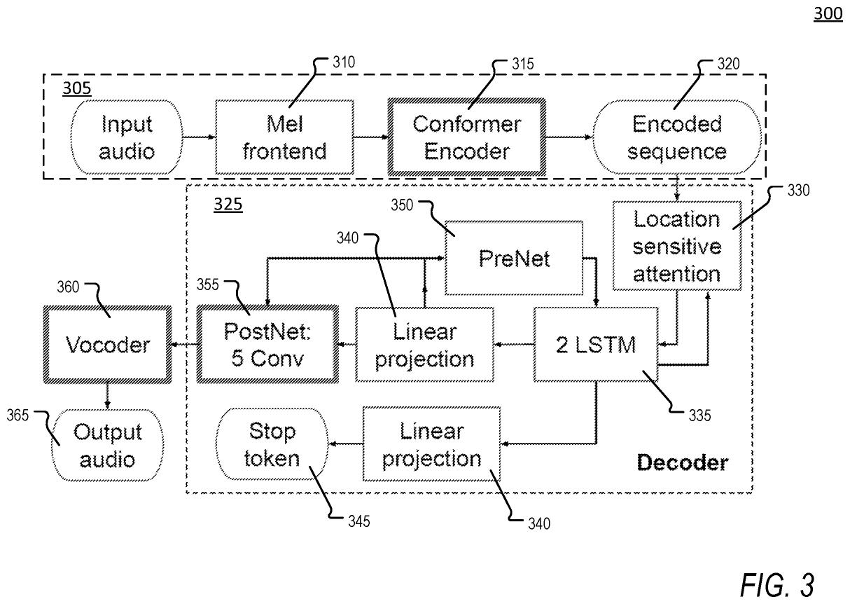

FIG. 3 is a schematic of the streaming speech-to-speech model architecture with look-ahead 300 (herein referred to as “model architecture 300”), according to an embodiment of the present disclosure. In an embodiment, the model architecture 300 includes an encoder 305, a decoder 325, and a vocoder 360. The encoder 305 can be a conformer encoder 315. The model architecture 300 can also include a stack of 17 blocks after the conformer encoder 315, and the decoder 325 can be an auto-regressive long short-term memory (LSTM) decoder with cross attention. This can be followed by the vocoder 360 to synthesize a time-domain waveform. The encoder 305 can convert a sequence of acoustic frames into a hidden feature representation consumed by the decoder 325 to predict a linear spectrogram.

The model architecture 300 can be trained on a parallel corpus, where the input utterances are from the entire set of Librispeech data and the corresponding target utterances are the synthesis of their manual transcripts, using the Parallel WaveNet-based single-voice TTS system. The model architecture 300 can normalize speech from arbitrary speakers. All benchmarks can be performed with TFLite single-threaded on a Pixel4 CPU. The model architecture 300 can be designed using Lingvo. The method described herein effectively builds a many-to-one voice conversion system that normalizes speech from arbitrary speakers to a single canonical voice.

For evaluation, the Librispeech test-clean data set can be used. To evaluate the quality of the described speech conversion systems, an ASR process can be used to automatically transcribe the converted speech and then calculate and compare Word Error Rates (WERs) across systems. It has been shown that ASR WER strongly correlates with Mean Opinion Scores (MOS).

There are several approaches for streaming such a model. One is to stream the encoder and decoder simultaneously so that the model generates new speech while the user is speaking, or generates translated text while the user is speaking. Additionally or alternatively, for speech conversion, the encoder can be streamed while the user is speaking, and then the decoder can be streamed to generate new speech afterwards, similar to the way the decoder runs in the TTS model. This can be well suited for a face-to-face dialog and minimize the quality loss in comparison to a non-streaming baseline model, especially for dysarthric input speech conversion.

Non-streaming base model—the non-streaming base model can include a speech conformer encoder which feeds into a spectrogram decoder, word-piece (text) decoder, and a phoneme decoder, all of which are jointly trained using a multi-task learning objective. A word-piece (text) decoder and a phoneme decoder are not used during inference, so they are omitted.

In an embodiment, the encoder 305 includes a Mel frontend 310 configured to receive input audio data and the conformer encoder 315. The Mel frontend 310 can convert the received input audio data into a Mel-scale input for the conformer encoder 315, such as a Mel filterbank or Mel spectrogram, wherein the Mel-frequency spectrogram is related to the linear-frequency spectrogram, i.e., the short-time Fourier transform (STFT) magnitude. The Mel spectrogram can be obtained by applying a nonlinear transform to the frequency axis of the STFT, which is inspired by measured responses from the human auditory system, and summarizes the frequency content with fewer dimensions. The Mel-scale input can be transmitted to the conformer encoder 315. The conformer encoder 315 can then use a convolution subsampling network to downsample or extract shallow features of speech signals for conformer blocks. In an embodiment, the conformer encoder 315 can be a convolution-augmented transformer for speech recognition. In general, a conformer block can include, for example, four modules stacked together, e.g., a feed-forward module, a self-attention module, a convolution module, and a second feed-forward module at the end. The conformer encoder 315 can generate an encoded sequence 320, which can be transmitted to the decoder 325. Then, at every decoder 325 step, this sequence can be processed by a cross “location-sensitive attention”.

In an embodiment, the decoder 325 is a spectrogram decoder. The decoder 325 can include a location-sensitive attention process 330. The location-sensitive attention process 330 can extend an additive attention process to use cumulative attention weights from previous decoder time steps as an additional feature and encourages the model to move forward consistently through the input. That is, at every decoder 325 step, the encoded sequence 320 can be processed by the location-sensitive attention process 330, which uses cumulative attention weights from previous decoder 325 time steps as an additional feature. The decoder 325 can include two LSTM layers 335 and a PreNet 350. The prediction from the previous time step can be processed by the PreNet 350 (with two fully connected layers and 256 units each). Then, the output of the PreNet 350 can be concatenated with cross-attention context and passed through to two uni-directional LSTM layers 335 (with 1024 units). An output of the LSTM layers 335 and an attention context can be concatenated and passed through to a linear projection process 340, which predicts two frames, each of which are 12.5 ms, per call. These frames can then be processed by a PostNet 355 including 5 convolutional layers and added as a residual connection to the output of the linear projection process 340. An output of the PostNet 355 can be two linear spectrogram frames which can be passed through to the vocoder 360 to generate a time-domain waveform of the converted speech. In an embodiment, the vocoder 360 can generate output audio including the time-domain waveform of the converted speech. In addition, the concatenation of the LSTM layers 335 output and the attention context can be passed through the linear projection process 340, which predicts if this is the end frame, resulting in a stop token 345.

The benchmarks for a model, such as the non-streaming model, can be divided into three parts: the encoder 305, the decoder 325, and the vocoder 360. Notably, 10 seconds of audio can be processed, and 6 seconds of audio can be generated. Further, int8 post training quantization can be applied and both float32 and int8 latency are shown in Table 1. In addition, non-streaming Griffin Lim (nGL) and streaming Griffin Lim (GL) were benchmarked. Table 1 shows that on-device latency is more than several seconds, while an acceptable user experience can be less than 300 ms of latency.

TABLE 1
10 s benchmark of non-
streaming model on Pixel4

| | Latency [sec] | Latency [sec] |
|---|---|---|
| Model part | float32 | Int8 |
| Encoder | 2.8 | 2.6 |
| Decoder | 2.7 | 2.4 |
| Vocoder sGL | 2.4 | |
| Vocoder nGL | 7 | |

Non-streaming encoder with streaming decoder—a model can have an encoder running in non-streaming mode (so that it uses full self-attention in conformer layers), and a decoder receives the whole encoded sequence and generates output audio in streaming mode. Non-causal convolutional layers in the PostNet 355 can be replaced with causal convolution so that it is easy to stream its output (and name this streaming-aware decoder “sDec”). Optimized versions of the vocoders can be used, such as sGL1 (streaming Griffin Lim) and sMelGAN1 (streaming MelGAN, or streaming MG). Both versions of the vocoders can look-ahead into 1 hop size leading to a delay of 12.5 ms. To optimize latency of the sGL1 vocoder, the parameters were set as: w_size=3, n_iters=3 and ind=1. To optimize latency of the sMelGAN1 vocoder, two frames were processed at once and streaming with external states was used. sGL1 was used because of the minimum model size of 0.1 MB shown in Table 2. sMelGAN1 was used because it is fully convolutional and, as a result, can process multiple samples per streaming inference call. This makes it more latency efficient in comparison to sequential models as shown in Table 2. The latency of processing two frames (which generates 25 ms of audio) in streaming, the TFLite model size, and the Real Time Factor (RTF is the ratio of the input length to the processing time) are shown in Table 2.

TABLE 2
25 ms benchmark of streaming vocoders on Pixel4

| | sGL1 | sMelGAN1 |
|---|---|---|
| Latency [ms] | 7.4 | 4.8 |
| RTF | 3.4 | 5.2 |
| Model size [MB] | 0.1 | 25 |
| Delay [ms] | 12.5 | 12.5 |

With all of the above, the decoder 325 and the vocoder 360 in streaming mode can be run and 25 ms of audio per inference call can be generated (with the condition that the whole input sequence is encoded and stored in the encoded sequence 320). The decoder 325 and the vocoders 360 can be benchmarked using TFLite on a single-threaded Pixel4 CPU, the results of which are shown in Table 3. To reduce model size, int8 post training quantization can be applied and its size and latency are reported in Table 3. The streaming decoder 325 generates 2 frames per call and the vocoder 360 converts it into 25 ms of audio.

The model size of GL is 0.1 MB, which is a key advantage over MG (25 MB). While MG can include a larger memory footprint, it is fully convolutional, allowing processing of multiple samples per streaming inference step in parallel—a major latency advantage over sequential vocoders, such as GL and WaveRNN. The use of int8 version of the decoder also exerts substantial improvements for all metrics over float32.

TABLE 3
25 ms benchmark of streaming
decoder and vocoders on Pixel4

| | float32 decoder | | int8 decoder | |
|---|---|---|---|---|
| | sGL1 | sMelGAN1 | sGL1 | sMelGAN1 |
| Latency [ms] | 16.0 | 13.4 | 13.6 | 11.0 |
| RTF | 1.6x | 1.9x | 1.8x | 2.3x |
| Size [MB] | 122 | 147 | 30 | 55 |

In an embodiment, several combinations can be evaluated: i) Base model with non-streaming encoder (nEnc), non-streaming decoder (nDec), and non-streaming GL (nGL); ii) Model with non-streaming encoder (nEnc), streaming decoder (sDec), and non-streaming GL (nGL); iii) Model with non-streaming encoder (nEnc), streaming decoder (sDec), and streaming vocoder sGL1; and iv) Model with non-streaming encoder (nEnc), streaming decoder (sDec), and streaming vocoder sMelGan1.

In an embodiment, the models can be evaluated using Librispeech test clean data: generated speech is recognized by Google's ASR and word error rate (WER) is reported. The evaluation results on Librispeech test clean data sets are shown in Table 4. Notably, there is no difference in model WER after making the streaming decoder aware (by replacing non-causal convolutions with a causal convolution), there is minimal accuracy drop after replacing the non-streaming GL with sGL1, and there is a 1.2% WER drop on the model with the streaming decoder and the sMelGan1 vocoder. Therefore, the causality of convolutional layers in the PostNet 355 does not reduce model accuracy.

TABLE 4
Model word error rate with streaming decoder

| float32 model | WER [%] |
|---|---|
| Base: nEnc, nDec, nGL | 14.7 |
| nEnc, sDec, nGL | 14.7 |
| nEnc, sDec, sGL1 | 14.8 |
| nEnc, sDec, sMelGan1 | 16.0 |

Causal streaming encoder with streaming decoder—described previously was a model where the decoder 325 and the vocoder 360 can generate output audio in real time. The remaining investigation includes running the encoder 305 in streaming mode and combining it with the streaming decoder and vocoder. The standard approach for the streaming encoder is to make all layers causal.

A Stacker Layer (denoted as SL) is a layer that is inserted between any pair of Conformer Blocks (CB). This layer stacks the current hidden-state with k hidden-states from either the future or past context followed by a linear projection to the original hidden-state dimension. This layer effectively summarizes those hidden-states into a single vector. The stacking layer also applies 2× sub-sampling to reduce the time dimension by 2×, which in turn reduces the computation requirement during self-attention.

The fully causal model can include a streaming decoder, streaming vocoder (GL), and a streaming causal encoder built using the following stack of layers: (1) Two conformer blocks that have access to only 65 hidden-states from the left (i.e., left context of 65) (denoted 2×CB); (2) SL that stacks current hidden-state and a hidden-state from the left context; (3) 2×CB; (4) followed by another SL; and finally (5) 13×CB. Note that this encoder uses two stacking layers, thus it reduces the sampling rate by 4×. Since all layers of this encoder have access to only the left context, a casual encoder is obtained.

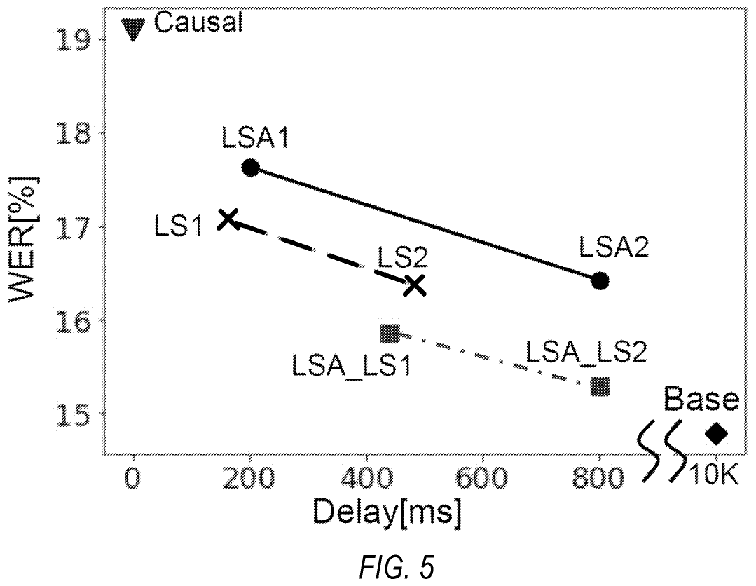

Results of different approaches in terms of WER and algorithmic delay are shown in FIG. 5. Unsurprisingly, the Causal model (triangle) has the highest WER (19.1%) in comparison to the non-streaming Base model (labeled with diamond) (14.7%); however it has the lowest delay (0 ms) since it generates intermediate states immediately after each spoken frame, whereas the Base model requires the entire utterance to complete to emit output (takes 10 s).

Layer names which are used in the streaming-aware encoder are: SL—the stacker which stacks current and one frame on the left side (in the past) and subsample frames by 2× (the layer which performs the subsampling is underlined); CB—conformer block with causal self-attention which attends to the left 65 frames (in the past); 2×CB—denotes that there is a sequence of 2 (in general it can be any number) causal conformer blocks with self-attention which attends to the left 65 frames (in the past). Two models to evaluate the impact of causality and sample rate on quality are introduced:
i) st00 has a streaming decoder, streaming vocoder (sGL1), and a streaming encoder with the following layers: [2×CB, SL, 2×CB, SL, 13×CB]. This encoder uses two sub-sampling layers, so it will reduce the sampling rate by 4×.
ii) st000 has a streaming decoder, streaming vocoder (sGL1) and a streaming encoder with the following layers: [2×CB, SL, 3×CB, SL, 3×CB, SL, 9×CB]. This encoder uses three sub-sampling layers, so it will reduce the sampling rate by 8×.

Non-causal streaming encoder with look-ahead self-attention and streaming decoder—as a trade-off between a fully causal (optimal delay) and non-causal encoder (optimal quality), look-ahead in self-attention in the conformer blocks is explored. This is similar to ASR encoders which include future/right hidden-states to improve quality over a fully casual model. A streaming aware non-causal conformer block with self-attention looking at the left 65 hidden-states and a limited look ahead of the right/future 5 hidden-states is denoted as “CB_{R5}”. Two different streaming-aware encoder configurations are built using these Look-ahead Self-Attention (LSA) layers alongside the stacking layers to identify a latency efficient model that also minimizes the loss in quality when compared to a non-causal encoder. The following two configurations are combined with the streaming decoder sDec and streaming vocoder GL to achieve a streaming-aware STS system:
i) LSA1: [2×CB, SL, 2×CB, SL, 3×CB, CB_{R5}, 9×CB]; and
ii) LSA2: [2×CB, SL, 2×CB, SL, 2×CB, CB_{R4}, CB, CB_{R4}, CB, CB_{R4}, 2×CB, CB_{R4}, CB, CB_{R4}, CB].

The results of these two models are shown in FIG. 5 (labeled with circles). As expected, the more hidden-states exploited in the future for the look-ahead self-attention, the higher the delay (as in LSA2). Interestingly though, using such a moderate right self-attention context leads to significantly better speech conversion quality (WER for LSA1 of 17.6% vs. WER for LSA2 of 16.4%). Note that these models in fact show a tangible trade-off between delay and WER when compared to the two extremes: Casual and Base.

Instead of enabling the conformer block self-attention to look-ahead at a fixed window of future hidden-states, as discussed above, a new strided non-causal stacker layer is introduced that explicitly utilizes those states in the current hidden-state. Specifically, the stacker layer now stacks k right/future hidden-states with the current hidden-state and projects them into a single vector, followed by 2× subsampling. A stacker layer denoted SL_{R5}, for example, summarizes the current plus 5 future hidden-states into a single vector. Since each hidden-state now includes information from the future, that self-attention can be more likely to make use of this information in combination with standard causal conformer blocks as opposed to having them modeled by the self-attention independently, risking low attention weights. Below, two configurations of encoders using Stacker Layers with different number of look-aheads are compared:
i) LS1: [2×CB, SL_{R3}, 3×CB, SL_{R4}, 12×CB]; and
ii) LS2: [2×CB, SL_{R3}, 3×CB, SL_{R5}, 3×CB, SL_{R6}, 9×CB].

As shown in FIG. 5, the results of these models are labeled with crosses. The look-ahead stacker layers are superior when compared to self-attention look-ahead in both metrics. LS models outperform LSA models by 0.5% absolute with even less delay.

Non-causal streaming encoder with look-ahead stacker and streaming decoder—finally, combining both types of look-aheads—self-attention look-ahead and look-ahead stacker—two other encoders are evaluated that use different numbers of stackers and look-ahead windows:
i) LSA LS1: [2×CB, SL_{R7}, 3×CB, SL_{R9}, 10×CB, CB_{R4}, CB]; and
ii) LSA LS2: [2×CB, SL_{R7}, 3×CB, SL_{R6}, 3×CB, SL_{R4}, 5×CB, CB_{R4}, CB, CB_{R4}, CB]

These two configurations that combine self-attention look-ahead and the stacker look-ahead layers (labeled with squares in FIG. 5), show the optimal trade-off between latency and WER. They outperform all other streaming models. With the best streaming model LSA_LS2 (with WER=15.3%), the difference with non-streaming baseline becomes 0.6% absolute. This is while substantially reducing the delay (down to 800 ms) when compared to the Base model (10 seconds). Using this encoder with the streaming decoder and vocoder builds the optimal streaming-aware speech conversion system.

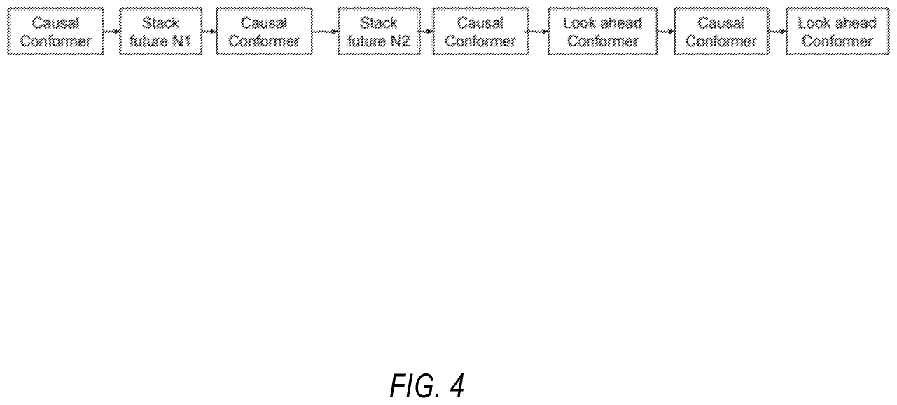

FIG. 4 is a schematic of the structure of the hybrid look-ahead model, according to an embodiment of the present disclosure. In an embodiment, the first layer is the causal conformer, then its features are stacked on the future N1 samples, projected, then subsampling in time is applied (to reduce future computations), then several causal conformers can be applied, then another stacking of N2 future samples is applied with subsampling, which is followed by causal conformer layers with conformer layer, which uses the look-ahead feature.

The aforementioned models are evaluated by training them on Librispeech and subsequently tested on Librispeech clean test data. The WER for the models and algorithmic delay are shown in FIG. 5. FIG. 5 is a graph of the float32 model accuracy versus delay trade-off (with streaming encoder decoder sDec and vocoder sGL1), according to an embodiment of the present disclosure. Models with causal encoders (triangles) have the lowest accuracy in comparison to the non-streaming base model (labeled with the diamond). The causal model with 8× subsampling is slightly better than the model with 4× subsampling. Models with non-causal stackers (crosses) have better accuracy and delay in comparison to models with non-causal self-attention layers (circles). At the same time with delay increase, non-causal stacker models saturate in quality. This can be explained by the fact that with stacking more frames (delay is increased), information is compressed a lot by projecting stacked frames back 512 units, whereas models with non-causal self-attention continue to improve with the delay increase. That is why combination of the non-causal stacker with non-causal self-attention is proposed. The hybrid models (squares) thus outperform the other non-causal streaming approaches.

The use of weight and activation quantization is explored to reduce the memory footprint and latency of the streaming model. int8 post training quantization is applied. To further reduce the encoder size, a hybrid approach of int4 weight and int8 activation quantization aware training is performed for the encoder.

The streaming-aware encoder LSA_LS2 can be benchmarked on a Pixel4. As shown in Table 5, the latency of processing 80 ms of audio (the streaming portion) is only 40 ms using float32 and 32 ms using int8 quantization. This also leads to an encoder size of about 70 MB (int4). Float and quantized encoders can run in real time: RTF≥2×. Although the delay of the LSA_LS2 encoder is 800 ms (see FIG. 5), the perceived delay (the time between the user stops speaking and the model starts generating speech) of the quantized encoder is 800 ms/RTF=320 ms (shown in Table 5).

The impact of quantization on quality was also analyzed. For testing the streaming model, the WER was determined for both the int4 and int8 quantized LSA_LS2 encoder while always using the int8 streaming decoder (sDec) with the streaming vocoders GL and MG. The results are shown in Table 6. It was observed that the use of GL always exerts significantly better quality than MG. There is only a loss of 0.2% in WER if the int4 quantization is used for the encoder. Quantization of both encoder and decoder does not substantially impact quality. The difference between the non-streaming Base model (10 second delay) and the best proposed streaming STS conversion system (320 ms delay) in terms of WER is only 0.7%.

In an embodiment, it may be appreciated that while the on-device processing is described above, the server (the second electronic device 110) can also be used instead and provide additional processing power. For example, the server can be a cloud server. The main difference from the on-device processing is that the first electronic device 105 can send the speech to the server in streaming mode, and then server will process the speech and send the output speech in streaming mode to the first electronic device. On the server, there can be greater processing power, so the server can process, for example, one minute or more of the speech.

In one advantage of the on-device processing, the first electronic device 105 can be communicatively disconnected from other devices and still function to perform the STS conversion. In the server-based example, the first electronic device 105 would need to be communicatively connected to the server via a wired or wireless connection to process the speech.

In another advantage of on-device processing, privacy and data security can be maintained since the first electronic device 105 is not transmitting data to another device, which can be a source of a security breach.

In another advantage of on-device processing, the first electronic device 105 can, immediately and over time, generate a personalized model or profile for a specific user or speaker. That is, a personalized model can be trained for each user, which can be easier to establish, store, and maintain on-device compared to a server establishing, storing, and maintaining, hundreds, thousands, millions, etc. profiles on the server.

TABLE 5
80 ms benchmark of streaming encoder on Pixel4

| | float32 | int8 |
|---|---|---|
| Latency [ms] | 40 | 32 |
| RTF | 2x | 2.5x |
| Size [MB] | 436 | 111 (70* with int4) |
| Perceived delay [ms] | 400 | 320 |

TABLE 6
WERs of the end-to-end STS conversion
system with quantized encoder look-ahead
self-attention and stacker look-ahead
layers streaming decoder and vocoders.

| | sGL1 | sMelGAN1 |
|---|---|---|
| stream encoder int8, | 15.4 | 15.9 |
| stream decoder int8 | | |
| stream encoder int4, | 15.6 | 15.8 |
| stream decoder int8 | | |

In conclusion, an on-device streaming aware model for speech-to-speech conversion was described herein. The proposed model includes a streaming-aware encoder 305, a streaming decoder 325, and a streaming vocoder 360. This model can run in real time: the encoder 305 can run with a RTF of 2.5×, and the decoder 325 (with the vocoder 360 included) can run with a RTF of 1.6× to 2.3×. After int8 encoder and decoder quantization, the total model size is 111 MB plus 30 MB (and with int4 encoder quantization, the model size is reduced to 70 MB plus 30 MB). The optimized configuration runs with a Real-Time-Factor of 2× and a delay of only 320 ms between the time the user stops speaking and when emitting the converted speech, whereas the non-streaming model requires a 10-second delay. Comparing the optimized model to a fully casual model, significant absolute error reduction is obtained with only a 0.7% error degradation when compared to a full context non-streaming model. It is a minimal trade-off for running such an STS conversion system locally on-device.

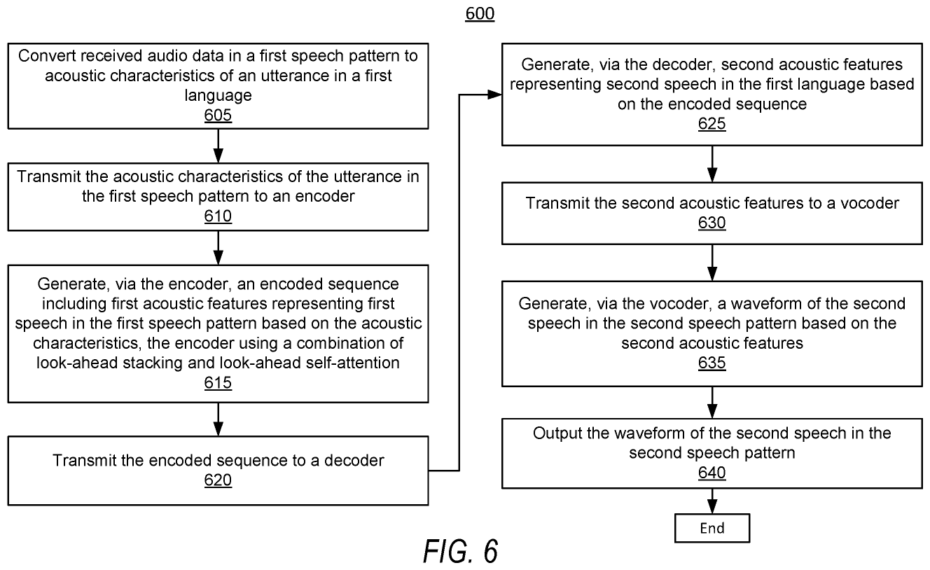

FIG. 6 is a flow chart for a method 600 of generating translated audio, according to an embodiment of the present disclosure. In an embodiment, step 605 is converting received audio data in a first speech pattern to acoustic characteristics of an utterance in a first language.

In an embodiment, step 610 is transmitting the acoustic characteristics of the utterance in the first speech pattern to an encoder.

In an embodiment, step 615 is generating, via the encoder, an encoded sequence including first acoustic features representing first speech in the first speech pattern based on the acoustic characteristics, the encoder using a combination of look-ahead stacking and look-ahead self-attention.

In an embodiment, step 620 is transmitting the encoded sequence to a decoder.

In an embodiment, step 625 is generating, via the decoder, second acoustic features representing second speech in the first language based on the encoded sequence.

In an embodiment, step 630 is transmitting the second acoustic features to a vocoder.

In an embodiment, step 635 is generating, via the vocoder, a waveform of the second speech in the first language based on the second acoustic features.

In an embodiment, step 640 is outputting the waveform of the second speech in the first language.

Embodiments of the subject matter and the functional operations described in this specification are implemented by processing circuitry (on one or more of electronic device 105 and 110), in tangibly embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory program carrier for execution by, or to control the operation of a data processing apparatus/device, (such as the devices of FIG. 1 or the like). The computer storage medium can be a machine-readable storage device, a machine-readable storage substrate, a random or serial access memory device, or a combination of one or more of them.

The term “data processing apparatus” refers to data processing hardware and may encompass all kinds of apparatus, devices, and machines for processing data, including by way of example a programmable processor, a computer, or multiple processors or computers. The apparatus can also be or further include special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, a module, a software module, a script, or code, can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., an FPGA an ASIC.

Computers suitable for the execution of a computer program include, by way of example, general or special purpose microprocessors or both or any other kind of central processing unit. Generally, a CPU will receive instructions and data from a read-only memory or a random-access memory or both. Elements of a computer are a CPU for performing or executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few. Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more Such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients (user devices) and servers. A client and server are generally remote from each other and typically interact through a communication network. The relationship of client and server arises by virtue of computer programs running on the respective computers and having a client-server relationship to each other. In an embodiment, a server transmits data, e.g., an HTML, page, to a user device, e.g., for purposes of displaying data to and receiving user input from a user interacting with the user device, which acts as a client. Data generated at the user device, e.g., a result of the user interaction, can be received from the user device at the server.

Electronic device 700 shown in FIG. 7 can be an example of one or more of the devices shown in FIG. 1. In an embodiment, the device 700 may be a smartphone. However, the skilled artisan will appreciate that the features described herein may be adapted to be implemented on other devices (e.g., a laptop, a tablet, a server, an e-reader, a camera, a navigation device, etc.). The device 700 of FIG. 7 includes processing circuitry, as discussed above. The processing circuitry includes one or more of the elements discussed next with reference to FIG. 7. The device 700 may include other components not explicitly illustrated in FIG. 7 such as a CPU, GPU, frame buffer, etc. The device 700 includes a controller 710 and a wireless communication processor 702 connected to an antenna 701. A speaker 704 and a microphone 705 are connected to a voice processor 703.

The controller 710 may include one or more processors/processing circuitry (CPU, GPU, or other circuitry) and may control each element in the device 700 to perform functions related to communication control, audio signal processing, graphics processing, control for the audio signal processing, still and moving image processing and control, and other kinds of signal processing. The controller 710 may perform these functions by executing instructions stored in a memory 750. Alternatively, or in addition to the local storage of the memory 750, the functions may be executed using instructions stored on an external device accessed on a network or on a non-transitory computer readable medium.

The memory 750 includes but is not limited to Read Only Memory (ROM), Random Access Memory (RAM), or a memory array including a combination of volatile and non-volatile memory units. The memory 750 may be utilized as working memory by the controller 710 while executing the processes and algorithms of the present disclosure. Additionally, the memory 750 may be used for long-term storage, e.g., of image data and information related thereto.

The device 700 includes a control line CL and data line DL as internal communication bus lines. Control data to/from the controller 710 may be transmitted through the control line CL. The data line DL may be used for transmission of voice data, display data, etc.

The antenna 701 transmits/receives electromagnetic wave signals between base stations for performing radio-based communication, such as the various forms of cellular telephone communication. The wireless communication processor 702 controls the communication performed between the device 700 and other external devices via the antenna 701. For example, the wireless communication processor 702 may control communication between base stations for cellular phone communication.

The speaker 704 emits an audio signal corresponding to audio data supplied from the voice processor 703. The microphone 705 detects surrounding audio and converts the detected audio into an audio signal. The audio signal may then be output to the voice processor 703 for further processing. The voice processor 703 demodulates and/or decodes the audio data read from the memory 750 or audio data received by the wireless communication processor 702 and/or a short-distance wireless communication processor 707. Additionally, the voice processor 703 may decode audio signals obtained by the microphone 705.

The exemplary device 700 may also include a display 720, a touch panel 730, an operation key 740, and a short-distance communication processor 707 connected to an antenna 706. The display 720 may be an LCD, an organic electroluminescence display panel, or another display screen technology. In addition to displaying still and moving image data, the display 720 may display operational inputs, such as numbers or icons which may be used for control of the device 700. The display 720 may additionally display a GUI for a user to control aspects of the device 700 and/or other devices. Further, the display 720 may display characters and images received by the device 700 and/or stored in the memory 750 or accessed from an external device on a network. For example, the device 700 may access a network such as the Internet and display text and/or images transmitted from a Web server.

The touch panel 730 may include a physical touch panel display screen and a touch panel driver. The touch panel 730 may include one or more touch sensors for detecting an input operation on an operation surface of the touch panel display screen. The touch panel 730 also detects a touch shape and a touch area. Used herein, the phrase “touch operation” refers to an input operation performed by touching an operation surface of the touch panel display with an instruction object, such as a finger, thumb, or stylus-type instrument. In the case where a stylus or the like is used in a touch operation, the stylus may include a conductive material at least at the tip of the stylus such that the sensors included in the touch panel 730 may detect when the stylus approaches/contacts the operation surface of the touch panel display (similar to the case in which a finger is used for the touch operation).

In certain aspects of the present disclosure, the touch panel 730 may be disposed adjacent to the display 720 (e.g., laminated) or may be formed integrally with the display 720. For simplicity, the present disclosure assumes the touch panel 730 is formed integrally with the display 720 and therefore, examples discussed herein may describe touch operations being performed on the surface of the display 720 rather than the touch panel 730. However, the skilled artisan will appreciate that this is not limiting.

For simplicity, the present disclosure assumes the touch panel 730 is a capacitance-type touch panel technology. However, it should be appreciated that aspects of the present disclosure may easily be applied to other touch panel types (e.g., resistance-type touch panels) with alternate structures. In certain aspects of the present disclosure, the touch panel 730 may include transparent electrode touch sensors arranged in the X-Y direction on the surface of transparent sensor glass.

The touch panel driver may be included in the touch panel 730 for control processing related to the touch panel 730, such as scanning control. For example, the touch panel driver may scan each sensor in an electrostatic capacitance transparent electrode pattern in the X-direction and Y-direction and detect the electrostatic capacitance value of each sensor to determine when a touch operation is performed. The touch panel driver may output a coordinate and corresponding electrostatic capacitance value for each sensor. The touch panel driver may also output a sensor identifier that may be mapped to a coordinate on the touch panel display screen. Additionally, the touch panel driver and touch panel sensors may detect when an instruction object, such as a finger is within a predetermined distance from an operation surface of the touch panel display screen. That is, the instruction object does not necessarily need to directly contact the operation surface of the touch panel display screen for touch sensors to detect the instruction object and perform processing described herein. For example, in an embodiment, the touch panel 730 may detect a position of a user's finger around an edge of the display panel 720 (e.g., gripping a protective case that surrounds the display/touch panel). Signals may be transmitted by the touch panel driver, e.g., in response to a detection of a touch operation, in response to a query from another element based on timed data exchange, etc.

The touch panel 730 and the display 720 may be surrounded by a protective casing, which may also enclose the other elements included in the device 700. In an embodiment, a position of the user's fingers on the protective casing (but not directly on the surface of the display 720) may be detected by the touch panel 730 sensors. Accordingly, the controller 710 may perform display control processing described herein based on the detected position of the user's fingers gripping the casing. For example, an element in an interface may be moved to a new location within the interface (e.g., closer to one or more of the fingers) based on the detected finger position.

Further, in an embodiment, the controller 710 may be configured to detect which hand is holding the device 700, based on the detected finger position. For example, the touch panel 730 sensors may detect a plurality of fingers on the left side of the device 700 (e.g., on an edge of the display 720 or on the protective casing), and detect a single finger on the right side of the device 700. In this exemplary scenario, the controller 710 may determine that the user is holding the device 700 with his/her right hand because the detected grip pattern corresponds to an expected pattern when the device 700 is held only with the right hand.

The operation key 740 may include one or more buttons or similar external control elements, which may generate an operation signal based on a detected input by the user. In addition to outputs from the touch panel 730, these operation signals may be supplied to the controller 710 for performing related processing and control. In certain aspects of the present disclosure, the processing and/or functions associated with external buttons and the like may be performed by the controller 710 in response to an input operation on the touch panel 730 display screen rather than the external button, key, etc. In this way, external buttons on the device 700 may be eliminated in lieu of performing inputs via touch operations, thereby improving watertightness.

The antenna 706 may transmit/receive electromagnetic wave signals to/from other external apparatuses, and the short-distance wireless communication processor 707 may control the wireless communication performed between the other external apparatuses. Bluetooth, IEEE 802.11, and near-field communication (NFC) are non-limiting examples of wireless communication protocols that may be used for inter-device communication via the short-distance wireless communication processor 707.

The device 700 may include a motion sensor 708. The motion sensor 708 may detect features of motion (i.e., one or more movements) of the device 700. For example, the motion sensor 708 may include an accelerometer to detect acceleration, a gyroscope to detect angular velocity, a geomagnetic sensor to detect direction, a geo-location sensor to detect location, etc., or a combination thereof to detect motion of the device 700. In an embodiment, the motion sensor 708 may generate a detection signal that includes data representing the detected motion. For example, the motion sensor 708 may determine a number of distinct movements in a motion (e.g., from start of the series of movements to the stop, within a predetermined time interval, etc.), a number of physical shocks on the device 700 (e.g., a jarring, hitting, etc., of the electronic device), a speed and/or acceleration of the motion (instantaneous and/or temporal), or other motion features. The detected motion features may be included in the generated detection signal. The detection signal may be transmitted, e.g., to the controller 710, whereby further processing may be performed based on data included in the detection signal. The motion sensor 708 can work in conjunction with a Global Positioning System (GPS) section 760. The information of the present position detected by the GPS section 760 is transmitted to the controller 710. An antenna 761 is connected to the GPS section 760 for receiving and transmitting signals to and from a GPS satellite.

The device 700 may include a camera section 709, which includes a lens and shutter for capturing photographs of the surroundings around the device 700. In an embodiment, the camera section 709 captures surroundings of an opposite side of the device 700 from the user. The images of the captured photographs can be displayed on the display panel 720. A memory section saves the captured photographs. The memory section may reside within the camera section 709 or it may be part of the memory 750. The camera section 709 can be a separate feature attached to the device 700 or it can be a built-in camera feature.

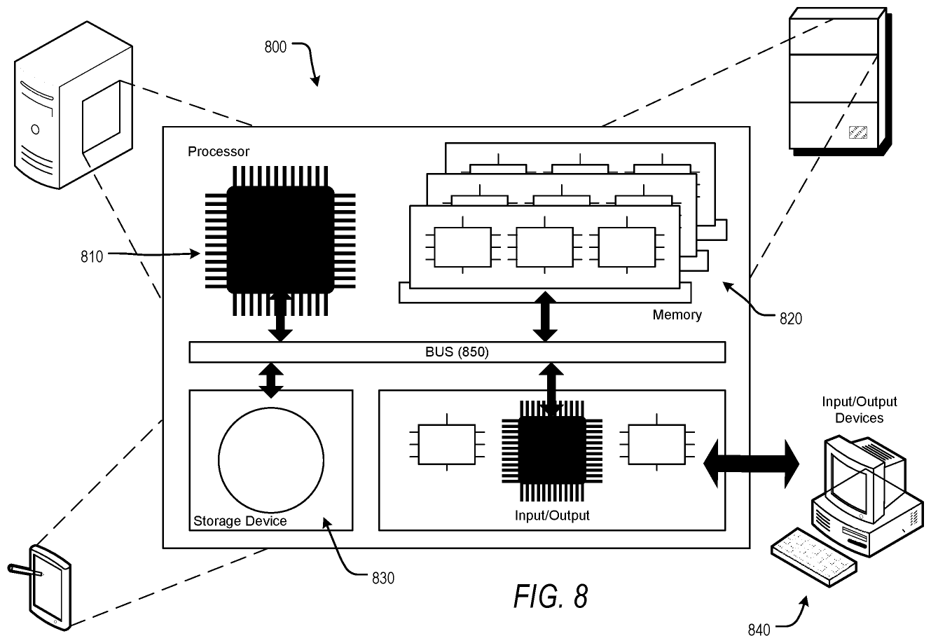

An example of a type of computer is shown in FIG. 8. The computer 800 can be used for the operations described in association with any of the computer-implement methods described previously, according to one implementation. For example, the computer 800 can be an example of the first electronic device 105, or a server (such as the second electronic device 110). The computer 800 includes processing circuitry, as discussed above. The device 850 may include other components not explicitly illustrated in FIG. 8 such as a CPU, GPU, frame buffer, etc. The processing circuitry includes one or more of the elements discussed next with reference to FIG. 8. In FIG. 8, the computer 800 includes a processor 810, a memory 820, a storage device 830, and an input/output device 840. Each of the components 810, 820, 830, and 840 are interconnected using a system bus 850. The processor 810 is capable of processing instructions for execution within the system 800. In one implementation, the processor 810 is a single-threaded processor. In another implementation, the processor 810 is a multi-threaded processor. The processor 810 is capable of processing instructions stored in the memory 820 or on the storage device 830 to display graphical information for a user interface on the input/output device 840.

The memory 820 stores information within the computer 800. In one implementation, the memory 820 is a computer-readable medium. In one implementation, the memory 820 is a volatile memory. In another implementation, the memory 820 is a non-volatile memory.

The storage device 830 is capable of providing mass storage for the system 800. In one implementation, the storage device 830 is a computer-readable medium. In various different implementations, the storage device 830 may be a floppy disk device, a hard disk device, an optical disk device, or a tape device.

The input/output device 840 provides input/output operations for the computer 800. In one implementation, the input/output device 840 includes a keyboard and/or pointing device. In another implementation, the input/output device 840 includes a display for displaying graphical user interfaces.

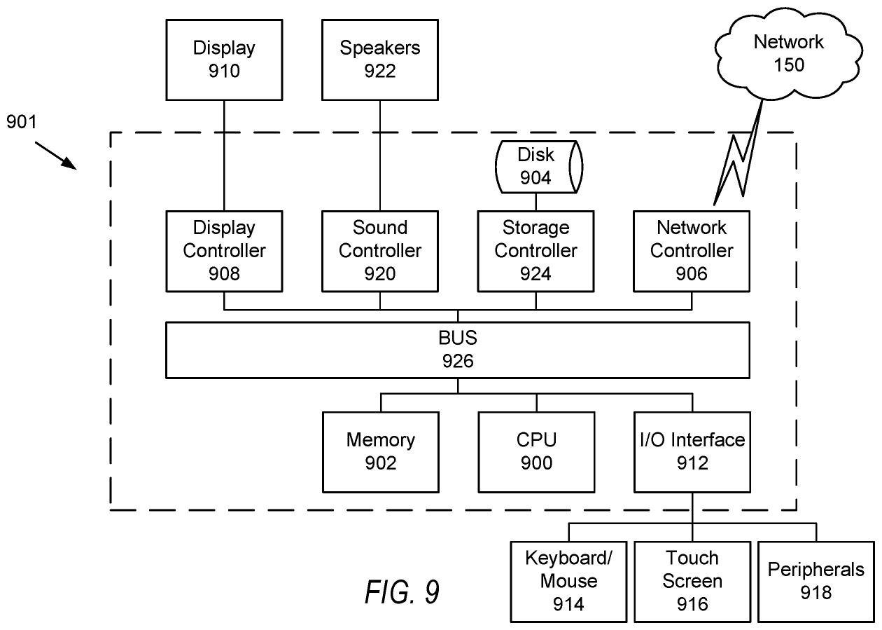

Next, a hardware description of a device 901 according to exemplary embodiments is described with reference to FIG. 9. In FIG. 9, the device 901, which can be the above described devices of FIG. 1, includes processing circuitry, as discussed above. The processing circuitry includes one or more of the elements discussed next with reference to FIG. 9. The device 901 may include other components not explicitly illustrated in FIG. 9 such as a CPU, GPU, frame buffer, etc. In FIG. 9, the device 901 includes a CPU 900 which performs the processes described above/below. The process data and instructions may be stored in memory 902. These processes and instructions may also be stored on a storage medium disk 904 such as a hard drive (HDD) or portable storage medium or may be stored remotely. Further, the claimed advancements are not limited by the form of the computer-readable media on which the instructions of the inventive process are stored. For example, the instructions may be stored on CDs, DVDs, in FLASH memory, RAM, ROM, PROM, EPROM, EEPROM, hard disk or any other information processing device with which the device communicates, such as a server or computer.

Further, the claimed advancements may be provided as a utility application, background daemon, or component of an operating system, or combination thereof, executing in conjunction with CPU 900 and an operating system such as Microsoft Windows, UNIX, Solaris, LINUX, Apple MAC-OS and other systems known to those skilled in the art.

The hardware elements in order to achieve the device may be realized by various circuitry elements, known to those skilled in the art. For example, CPU 900 may be a Xenon or Core processor from Intel of America or an Opteron processor from AMD of America, or may be other processor types that would be recognized by one of ordinary skill in the art. Alternatively, the CPU 900 may be implemented on an FPGA, ASIC, PLD or using discrete logic circuits, as one of ordinary skill in the art would recognize. Further, CPU 900 may be implemented as multiple processors cooperatively working in parallel to perform the instructions of the processes described above. CPU 900 can be an example of the CPU illustrated in each of the devices of FIG. 1.

The device 901 in FIG. 9 also includes a network controller 906, such as an Intel Ethernet PRO network interface card from Intel Corporation of America, for interfacing with the network 150 (also shown in FIG. 1), and to communicate with the other devices of FIG. 1. As can be appreciated, the network 150 can be a public network, such as the Internet, or a private network such as an LAN or WAN network, or any combination thereof and can also include PSTN or ISDN sub-networks. The network 150 can also be wired, such as an Ethernet network, or can be wireless such as a cellular network including EDGE, 3G, 4G and 5G wireless cellular systems. The wireless network can also be WiFi, Bluetooth, or any other wireless form of communication that is known.

The device further includes a display controller 908, such as a NVIDIA GeForce GTX or Quadro graphics adaptor from NVIDIA Corporation of America for interfacing with display 910, such as an LCD monitor. A general purpose I/O interface 912 interfaces with a keyboard and/or mouse 914 as well as a touch screen panel 916 on or separate from display 910. General purpose I/O interface also connects to a variety of peripherals 918 including printers and scanners.

A sound controller 920 is also provided in the device to interface with speakers/microphone 922 thereby providing sounds and/or music.

The general-purpose storage controller 924 connects the storage medium disk 904 with communication bus 926, which may be an ISA, EISA, VESA, PCI, or similar, for interconnecting all of the components of the device. A description of the general features and functionality of the display 910, keyboard and/or mouse 914, as well as the display controller 908, storage controller 924, network controller 906, sound controller 920, and general purpose I/O interface 912 is omitted herein for brevity as these features are known.

Obviously, numerous modifications and variations are possible in light of the above teachings. It is therefore to be understood that within the scope of the appended claims, embodiments of the present disclosure may be practiced otherwise than as specifically described herein.

While this specification contains many specific implementation details, these should not be construed as limitations on the scope of what may be claimed, but rather as descriptions of features that may be specific to particular embodiments.

Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Embodiments of the present disclosure may also be as set forth in the following parentheticals.

(1) A method of speech-to-speech conversion, comprising converting received audio data in a first language to acoustic characteristics of an utterance in the first language, the audio data comprising a sequence of acoustic frames; generating, via an encoder, an encoded sequence including first acoustic features representing first speech in the first language based on the acoustic characteristics, the encoder using a combination of look-ahead stacking of the acoustic frames and look-ahead self-attention of the acoustic frames; generating, via a decoder, second acoustic features representing second speech in a second speech pattern based on the encoded sequence; generating, via a vocoder, a waveform of the second speech in the second speech pattern based on the second acoustic features; and outputting the waveform of the second speech in the second speech pattern.

(2) The method of (1), wherein the generating the encoded sequence includes a conformer layer with self-attention looking at least 65 acoustic frames in the past relative to a current acoustic frame being analyzed.

(3) The method of either (1) or (2), wherein the generating the encoded sequence includes a look-ahead stacker which stacks a current acoustic frame and at least four acoustic frames in the future relative to a current frame being analyzed.

(4) The method of any one of (1) to (3), wherein the generating the encoded sequence includes subsampling the acoustic frames by 2×.

(5) The method of any one of (1) to (4), wherein the generating the encoded sequence includes a combination of a conformer layer with self-attention looking at least 65 acoustic frames in the past and a look-ahead stacker which stacks a current acoustic frame and four acoustic frames in the future relative to the current acoustic frame.

(6) The method of any one of (1) to (5), wherein the encoder is an int8 stream encoder and the decoder is an int8 stream decoder.

(7) The method of any one of (1) to (6), wherein a perceived delay between receiving the received audio data and outputting the waveform of the second speech in the second speech pattern is less than 350 ms.

(8) The method of any one of (1) to (7), wherein a size of the encoder and decoder quantization model is less than 200 MB.

(9) The method of any one of (1) to (8), wherein a real time factor of the encoder is 2.5× faster.

(10) The method of any one of (1) to (9), wherein a translated word error rate of the resulting waveform of the second speech in the second speech pattern is less than 16%.

(11) A non-transitory computer-readable storage medium for storing computer-readable instructions that, when executed by a computer, cause the computer to perform a method, the method comprising converting received audio data in a first language to acoustic characteristics of an utterance in the first language, the audio data comprising a sequence of acoustic frames; generating, via an encoder, an encoded sequence including first acoustic features representing first speech in the first language based on the acoustic characteristics, the encoder using a combination of look-ahead stacking of the acoustic frames and look-ahead self-attention of the acoustic frames; generating, via a decoder, second acoustic features representing second speech in a second speech pattern based on the encoded sequence; generating, via a vocoder, a waveform of the second speech in the second speech pattern based on the second acoustic features; and outputting the waveform of the second speech in the second speech pattern.

(12) The non-transitory computer-readable storage medium of (11), wherein the generating the encoded sequence includes a conformer layer with self-attention looking at least 65 acoustic frames in the past relative to a current acoustic frame being analyzed.

(13) The non-transitory computer-readable storage medium of either (11) or (12), wherein the generating the encoded sequence includes a look-ahead stacker which stacks a current acoustic frame and at least four acoustic frames in the future relative to a current frame being analyzed.

(14) The non-transitory computer-readable storage medium of any one of (11) to (13), wherein the generating the encoded sequence includes subsampling the frames by 2×.

(15) The non-transitory computer-readable storage medium of any one of (11) to (14), wherein the generating the encoded sequence includes a combination of a conformer layer with self-attention looking at least 65 acoustic frames in the past and a look-ahead stacker which stacks a current acoustic frame and four acoustic frames in the future relative to the current acoustic frame.

(16) The non-transitory computer-readable storage medium of any one of (11) to (15), wherein the encoder is an int8 stream encoder and the decoder is an int8 stream decoder.

(17) The non-transitory computer-readable storage medium of any one of (11) to (16), wherein a perceived delay between receiving the received audio data and outputting the waveform of the second speech in the second speech pattern is less than 350 ms.

(18) The non-transitory computer-readable storage medium of any one of (11) to (17), wherein a size of the encoder and decoder quantization model is less than 200 MB.

(19) The non-transitory computer-readable storage medium of any one of (11) to (18), wherein a translated word error rate of the resulting waveform of the second speech in the second speech pattern is less than 16%.

(20) An apparatus, comprising processing circuitry configured to convert received audio data in a first language to acoustic characteristics of an utterance in the first language, the audio data comprising a sequence of acoustic frames, generate, via an encoder, an encoded sequence including first acoustic features representing first speech in the first language based on the acoustic characteristics, the encoder using a combination of look-ahead stacking of the acoustic frames and look-ahead self-attention of the acoustic frames, generate, via a decoder, second acoustic features representing second speech in a second speech pattern based on the encoded sequence, generate, via a vocoder, a waveform of the second speech in the second language based on the second acoustic features, and output the waveform of the second speech in the second language.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

Thus, the foregoing discussion discloses and describes merely exemplary embodiments of the present disclosure. As will be understood by those skilled in the art, the present disclosure may be embodied in other specific forms without departing from the spirit thereof. Accordingly, the disclosure of the present disclosure is intended to be illustrative, but not limiting of the scope of the disclosure, as well as other claims. The disclosure, including any readily discernible variants of the teachings herein, defines, in part, the scope of the foregoing claim terminology such that no inventive subject matter is dedicated to the public.

What is claimed is:

1. A method of speech-to-speech conversion, comprising:
converting received audio data in a first language to acoustic characteristics of an utterance in the first language, the audio data comprising a sequence of acoustic frames;
generating, via an encoder, an encoded sequence including first acoustic features representing first speech in the first language based on the acoustic characteristics, the encoder using a combination of look-ahead stacking of the acoustic frames and look-ahead self-attention of the acoustic frames;
generating, via a decoder, second acoustic features representing second speech in a second speech pattern based on the encoded sequence;
generating, via a vocoder, a waveform of the second speech in the second speech pattern based on the second acoustic features; and
outputting the waveform of the second speech in the second speech pattern.

2. The method of claim 1, wherein the generating the encoded sequence includes a conformer layer with self-attention looking at least 65 acoustic frames in the past relative to a current acoustic frame being analyzed.

3. The method of claim 1, wherein the generating the encoded sequence includes a look-ahead stacker which stacks a current acoustic frame and at least four acoustic frames in the future relative to a current frame being analyzed.

4. The method of claim 3, wherein the generating the encoded sequence includes subsampling the acoustic frames by 2×.

5. The method of claim 1, wherein the generating the encoded sequence includes a combination of a conformer layer with self-attention looking at least 65 acoustic frames in the past and a look-ahead stacker which stacks a current acoustic frame and four acoustic frames in the future relative to the current acoustic frame.

6. The method of claim 1, wherein the encoder is an int8 stream encoder and the decoder is an int8 stream decoder.

7. The method of claim 6, wherein a perceived delay between receiving the received audio data and outputting the waveform of the second speech in the second speech pattern is less than 350 ms.

8. The method of claim 6, wherein a size of the encoder and decoder quantization model is less than 200 MB.

9. The method of claim 6, wherein a real time factor of the encoder is 2.5× faster.

10. The method of claim 1, wherein a translated word error rate of the resulting waveform of the second speech in the second speech pattern is less than 16%.

11. A non-transitory computer-readable storage medium for storing computer-readable instructions that, when executed by a computer, cause the computer to perform a method, the method comprising:
converting received audio data in a first language to acoustic characteristics of an utterance in the first language, the audio data comprising a sequence of acoustic frames;
generating, via an encoder, an encoded sequence including first acoustic features representing first speech in the first language based on the acoustic characteristics, the encoder using a combination of look-ahead stacking of the acoustic frames and look-ahead self-attention of the acoustic frames;
generating, via a decoder, second acoustic features representing second speech in a second speech pattern based on the encoded sequence;
generating, via a vocoder, a waveform of the second speech in the second speech pattern based on the second acoustic features; and
outputting the waveform of the second speech in the second speech pattern.

12. The non-transitory computer-readable storage medium of claim 11, wherein the generating the encoded sequence includes a conformer layer with self-attention looking at least 65 acoustic frames in the past relative to a current acoustic frame being analyzed.

13. The non-transitory computer-readable storage medium of claim 11, wherein the generating the encoded sequence includes a look-ahead stacker which stacks a current acoustic frame and at least four acoustic frames in the future relative to a current frame being analyzed.

14. The non-transitory computer-readable storage medium of claim 13, wherein the generating the encoded sequence includes subsampling the acoustic frames by 2×.

15. The non-transitory computer-readable storage medium of claim 11, wherein the generating the encoded sequence includes a combination of a conformer layer with self-attention looking at least 65 acoustic frames in the past and a look-ahead stacker which stacks a current acoustic frame and four acoustic frames in the future relative to the current acoustic frame.

16. The non-transitory computer-readable storage medium of claim 11, wherein the encoder is an int8 stream encoder and the decoder is an int8 stream decoder.

17. The non-transitory computer-readable storage medium of claim 16, wherein a perceived delay between receiving the received audio data and outputting the waveform of the second speech in the second speech pattern is less than 350 ms.

18. The non-transitory computer-readable storage medium of claim 16, wherein a size of the encoder and decoder quantization model is less than 200 MB.

19. The non-transitory computer-readable storage medium of claim 16, wherein a translated word error rate of the resulting waveform of the second speech in the second speech pattern is less than 16%.

20. An apparatus, comprising:
processing circuitry configured to
convert received audio data in a first language to acoustic characteristics of an utterance in the first language, the audio data comprising a sequence of acoustic frames,
generate, via an encoder, an encoded sequence including first acoustic features representing first speech in the first language based on the acoustic characteristics, the encoder using a combination of look-ahead stacking of the acoustic frames and look-ahead self-attention of the acoustic frames,
generate, via a decoder, second acoustic features representing second speech in a second speech pattern based on the encoded sequence,
generate, via a vocoder, a waveform of the second speech in the second language based on the second acoustic features, and
output the waveform of the second speech in the second language.
